(19) United States
(12) Patent Application Publication
(10) Pub. No.: US 2025/0258095 A1
(43) Pub. Date: Aug. 14, 2025

(54) MULTI CELL DETECTION USING OPTICAL BEAM

(71) Applicant: LIFE SAFETY DISTRIBUTION GMBH, Rolle (CH)

(72) Inventor: Mohit Khurana, Gland (CH)

(21) Appl. No.: 18/440,211

(22) Filed: Feb. 13, 2024

(51) Int. Cl. G01N 21/45

(52) U.S. Cl. CPC G01N 21/45; G01N 2201/0446; G01N 2201/0636

(57) ABSTRACT

Various embodiments provide systems, methods, and apparatuses for detecting optical fluid detection. The apparatus may include an optical source configured to emit one or more optical test beams. The apparatus may further include a first mirror configured to reflect the one or more optical test beams. The apparatus may further include a plurality of fluid cells including a first fluid cell configured to pass the one or more optical test beams through a first fluid. The apparatus may further include a second mirror configured to reflect the one or more optical test beams after passing through the first fluid cell. The apparatus may further include a third mirror configured to reflect the one or more optical test beams after reflecting from the second mirror. The apparatus may further include an optical detector configured to receive the one or more optical test beams after reflecting from the third mirror.

### BACKGROUND

Fluid detection apparatuses, such as gas or liquid detection apparatuses may be used to detect various types of fluids, for example gases or liquids. Some detection apparatuses use multiple optical sources and multiple corresponding optical detectors to detect fluids, such as gases or liquids, in different areas or containers. However, they may suffer from redundancy of components and increased cost, weight and/or size. Through applied effort, ingenuity, and innovation, many of these identified problems have been solved by developing solutions that are included in embodiments of the present disclosure, examples of which are described in detail herein.

### BRIEF SUMMARY

Various embodiments provide systems, methods, and apparatuses for detecting optical fluid detection. In various embodiments, an apparatus for optical fluid detection is provided. The apparatus may include an optical source configured to emit one or more optical test beams. The apparatus may further include a first mirror configured to reflect the one or more optical test beams. The apparatus may further include a plurality of fluid cells including a first fluid cell configured to pass the one or more optical test beams through a first fluid. The apparatus may further include a second mirror configured to reflect the one or more optical test beams after passing through the first fluid cell. The apparatus may further include a third mirror configured to reflect the one or more optical test beams after reflecting from the second mirror. The apparatus may further include an optical detector configured to receive the one or more optical test beams after reflecting from the third mirror.

In various embodiments, the first mirror, the second mirror, and the third mirror are placed in fixed relative positions with respect to each other.

In various embodiments, the first fluid cell includes a first window of the first fluid cell configured to receive the one or more optical test beams after reflecting from the first mirror; a second window of the first fluid cell configured to pass the one or more optical test beams after passing through the first fluid cell; an inlet of the first fluid cell configured to pass the first fluid to the first fluid cell; and an outlet of the first fluid cell configured to pass the first fluid out of the first fluid cell.

In various embodiments, the first mirror, the second mirror and the third mirror are mechanically coupled to each other and are configured to rotate around a rotation axis such that at a first measurement time, the first mirror and the second mirror are positioned near two ends of the first fluid cell, and the first mirror is configured to reflect the one or more optical test beams to the first window of the first fluid cell and the second mirror is configured to receive the one or more optical test beams after passing through the first fluid cell from the second window of the first fluid cell and reflect it to the third mirror.

In various embodiments, the plurality of fluid cells includes a second fluid cell and the second fluid cell includes a first window of the second fluid cell configured to receive the one or more optical test beams after reflecting from the first mirror; a second window of the second fluid cell configured to pass the one or more optical test beams after passing through the second fluid cell; an inlet of the second fluid cell configured to pass a second fluid to the second fluid cell; and an outlet of the second fluid cell configured to pass the second fluid out of the second fluid cell.

In various embodiments, and at a second measurement time, the first mirror and the second mirror are positioned near the two ends of the second fluid cell, and the first mirror is configured to reflect the one or more optical test beams to the first window of the second fluid cell and the second mirror is configured to receive the one or more optical test beams after passing through the second fluid cell from the second window of the second fluid cell and reflect it to the third mirror.

In various embodiments, the optical detector is configured to detect a concentration of the first fluid in the first fluid cell during the first measurement time and a concentration of the second fluid in the second fluid cell during the second measurement time, by detecting an interferogram in the received one or more optical test beams.

In various embodiments, and at each measurement time of a plurality of measurement times, the first mirror is configured to reflect the one or more optical test beams in a direction of a corresponding fluid cell of the plurality of fluid cells, and the second mirror is configured to receive the one or more optical test beams after passing through the corresponding fluid cell.

In various embodiments, the plurality of fluid cells is arranged radially around the first mirror, and wherein the first mirror, the second mirror, and the third mirror are configured to rotate around a rotation axis such that at each measurement time of the plurality of measurement times, the first mirror is configured to reflect the one or more optical test beams in the direction of the corresponding fluid cell of the plurality of fluid cells, and the second mirror is configured to receive the one or more optical test beams after passing through the corresponding fluid cell.

In various embodiments, the plurality of fluid cells is arranged linearly, and wherein the first mirror, the second mirror, and the third mirror are configured to move linearly such that at each measurement time of the plurality of measurement times, the first mirror is configured to reflect the one or more optical test beams in the direction of the corresponding fluid cell of the plurality of fluid cells, and the second mirror is configured to receive the one or more optical test beams after passing through the corresponding fluid cell.

In various embodiments an additional or alternative apparatus for optical fluid detection is provided. The apparatus may include an optical source configured to emit one or more optical test beams. The apparatus may further include an optical source configured to emit one or more optical test beams. The apparatus may further include a first mirror configured to reflect the one or more optical test beams. The apparatus may further include a plurality of fluid cells, wherein each fluid cell of the plurality of fluid cells is configured to pass the one or more optical test beams through a corresponding fluid. The apparatus may further include an optical detector configured to receive the one or more optical test beams after passing through the fluid cell, wherein the plurality of fluid cells is arranged radially around the first mirror, and wherein the first mirror and the optical detector are configured to rotate around a rotation axis.

In various embodiments, the first mirror and the optical detector are mechanically coupled to each other.

In various embodiments, the first mirror and the optical detector are placed in fixed relative positions with respect to each other and are configured to rotate around the rotation axis such that at a measurement time of a plurality of measurement times corresponding to the fluid cell, the first mirror is configured to reflect the one or more optical test beams in the direction of the fluid cell, and the optical detector is configured to receive the one or more optical test beams after passing through the fluid cell.

In various embodiments, the optical detector is configured to detect a concentration of a fluid in the fluid cell during the measurement time by detecting an interferogram in the received one or more optical test beams after passing through the fluid cell.

In various embodiments, the optical detector is configured to transmit detection data to one or more computing devices over a wireless medium or a slip ring, and the optical detector is configured to receive power using a battery or the slip ring.

In various embodiments an additional or alternative apparatus for optical fluid detection is provided. The apparatus may include an optical source configured to emit one or more optical test beams. The apparatus may further include a first mirror configured to reflect the one or more optical test beams. The apparatus may further include a plurality of fluid cells, wherein each fluid cell of the plurality of fluid cells is configured to pass the one or more optical test beams through a corresponding fluid. The apparatus may further include an optical detector configured to receive the one or more optical test beams after passing through the fluid cell, and wherein the plurality of fluid cells is arranged linearly with respect to each other, and wherein the first mirror and the optical detector are configured to move linearly.

In various embodiments, the first mirror and the optical detector are mechanically coupled to each other.

In various embodiments, the first mirror and the optical detector are placed in fixed relative positions with respect to each other and are configured to move linearly such that at a measurement time of a plurality of measurement times corresponding to the fluid cell, the first mirror is configured to reflect the one or more optical test beams in the direction of the fluid cell, and the optical detector is configured to receive the one or more optical test beams after passing through the fluid cell.

In various embodiments, the optical detector is configured to detect a concentration of a fluid in the fluid cell during the measurement time by detecting an interferogram in the received one or more optical test beams after passing through the fluid cell.

In various embodiments, the optical detector is configured to transmit detection data to one or more computing devices over a wireless medium or a linear sliding electrical connection, and the optical detector is configured to receive power using a battery or the linear sliding electrical connection.

### BRIEF DESCRIPTION OF THE SEVERAL VIEWS OF THE DRAWINGS

FIG. 1 is a schematic diagram illustrating an optical fluid detection apparatus 100 in accordance with various embodiments of the present disclosure.

FIG. 2 is a schematic diagram illustrating a fluid cell 218 in accordance with various embodiments of the present disclosure.

FIG. 3 is a schematic diagram illustrating optical fluid detection apparatus 300 in accordance with various embodiments of the present disclosure.

FIG. 4 is a schematic diagram illustrating optical fluid detection apparatus 400 in accordance with various embodiments of the present disclosure.

FIG. 5 is a schematic diagram illustrating optical fluid detection apparatus 500 in accordance with various embodiments of the present disclosure.

FIG. 6 is a schematic diagram illustrating one or more computing device 606 in accordance with various embodiments of the present disclosure.

### DETAILED DESCRIPTION

The phrases “in one embodiment,” “according to one embodiment,” “in some embodiments,” “in various embodiments” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration” without a limitation. Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Use of broader terms such as “comprises,” “includes,” and “having” should be understood to provide support for narrower terms such as “consisting of,” “consisting essentially of,” and “comprised substantially of”. Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

The term “computing device” refers to any computer, controller (such as a microcontroller), processor, circuitry, and/or other executor of computer instructions that is embodied in hardware, software, firmware, and/or any combination thereof, that enables access to myriad functionalities associated with one or more mobile device(s), system(s), and/or one or more communications networks. Non-limiting examples of a computing device include a computer, a controller (such as a microcontroller), an application-specific integrated circuit, a field-programmable gate array, a personal computer, a smart phone, a laptop, a fixed terminal, a server, a networking device, a virtual machine, a processor, a plurality of processors electronically coupled to each other and placed in proximity of each other, remote from each other, in a various groups or bundles of one or more processors, and/or forming cloud computing or processing, etc. Other examples of computing devices are provided herein.

The term “electronically coupled,” “electronically coupling,” “electronically couple,” “in electronic communication with,” or “electronically connected” in the present disclosure refers to two or more elements or components being electronically connected, directly or indirectly. For example, two or more elements or components may be connected through wired means and/or wireless means, such that signals, voltage/current, data, information, or any other electronic signals may be transmitted to and/or received from these elements or components. Electronic connections established via an electrical connector and/or port may refer to wired connections.

The term “mechanically coupled” in the present disclosure refers to two or more mechanical elements (for example, but not limited to, a frame, a surface, a support unit, a joint, etc.) being physically connected in various ways such as directly, through intermediary elements, and/or using fastener(s), clasps, clamps, joints, pin joint, axle, hinge, adhesive, etc.

The term “mechanically coupled” may refer to any of movable, turntable, swiveling, pivoting, fixed, and/or stationary mechanical coupling and/or any other similar type of mechanical coupling. In a non-limiting example, two components are mechanically coupled using a force, such as but not limited to magnetic force, force caused by air pressure, adhesive force, mechanical force, and/or other similar or related forces.

The term “fluid” in the present disclosure refers to any gas, liquid, or generally any material that cannot sustain a fixed shape or a tangential, or shearing, force when at rest and is able to flow.

Detecting presence of a particular fluid or determining a fluid composition has many applications in detection systems, safety systems, gas or liquid material production and/or transportation systems, etc.

Fluid detection, such as gas detection may for example be achieved using spectroscopy techniques, such as single frequency spectroscopy, double frequency spectroscopy, etc. For example, in a frequency comb spectroscopy, a Dual Frequency Comb (DFC) source emits one or more optical test beams, such as laser beams, in two frequencies. The frequency ranges of one or more optical test beams may for example by in the Infrared (IR) light range.

The one or more optical test beams pass through a test fluid to determine presence of a particular fluid or determine a combination of the fluids. For example, a particular gas, such as carbon dioxide (CO₂), may absorb some frequencies or frequency ranges of the laser beams. An optical detector, such as a photodiode, may receive the one or more optical test beams after it passes through the fluid. In various embodiments, optical fluid detection apparatuses are provided for detecting transparent or partially transparent or translucent fluids.

The optical detector may be electronically coupled with one or more computing devices that are configured to use detection data to determine wavelengths or frequencies that are missing in the one or more optical test beams after passing through the fluid. Using the missing wavelengths or frequencies the one or more computing devices may determine presence of a particular fluid or a composition of the tested fluids. The one or more computing devices may use the data from the optical detector to determine an interferogram in the received one or more optical test beams. The one or more computing devices may use the interferogram to detect the particular fluid or the composition of the tested fluids.

Testing for different fluid samples may be a challenging process. It is desirable to test various fluid samples in a fast and efficient way. Various embodiments of the present disclosure provide methods, systems, and devices to test different fluid samples quickly and efficiently.

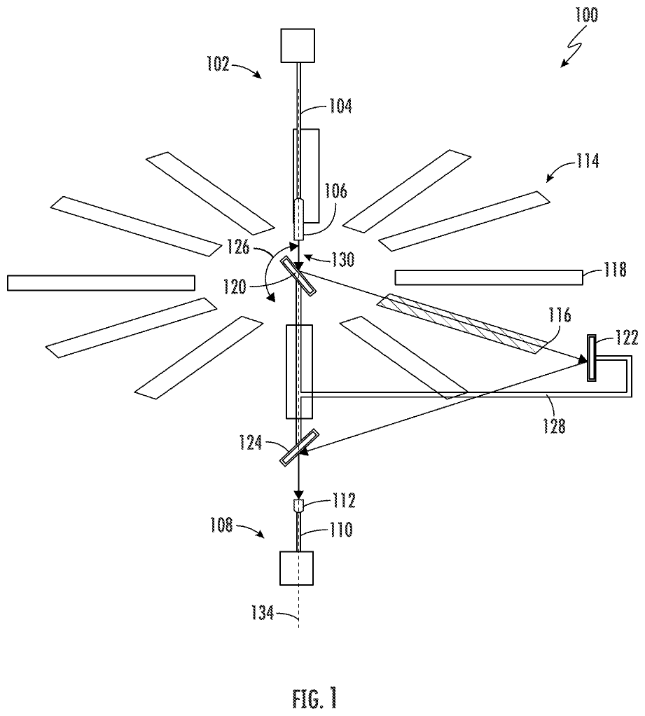

Referring now to FIG. 1 a schematic diagram illustrating an optical fluid detection apparatus 100 is provided in accordance with various embodiments of the present disclosure.

The optical fluid detection apparatus 100 may include an optical source 102 configured to emit one or more optical test beams 130, for example laser beams. In various embodiments, the optical source 102 may be a spectroscopy optical source. In various embodiments, the optical source 102 may be a Dual Frequency Comb (DFC) optical source and the optical fluid detection apparatus 100 may be a DFC based gas detection or analysis system.

In various embodiments, the optical source 102 may include an optical fiber 104 and an optical element 106. The optical fiber 104 may for example provide flexibility in routing the one or more optical test beams generated by the optical source 102. In various embodiments, the optical element 106 may be configured to provide beam forming, e.g., focusing, collimating, etc., on the one or more optical test beams. For example, the optical element 106 may be a lens, a refractive and/or a diffractive optical element.

In various embodiments, the optical fluid detection apparatus 100 includes a first mirror 120. The first mirror 120 may be configured to reflect the one or more optical test beams generated by the optical source 102 to a fluid cell of a plurality of fluid cells 114.

In various embodiments, the optical fluid detection apparatus 100 includes a plurality of fluid cells 114. Each fluid cell of the plurality of fluid cells 114 is configured to pass the one or more optical test beams after reflecting from the first mirror 120. In various embodiments, each fluid cell of the plurality of fluid cells 114 contains a corresponding fluid. The corresponding fluid may for example flow through the fluid cell or temporarily be contained in the fluid cell. For example, the plurality of fluid cells 114 include a first fluid cell 116 configured to pass the one or more optical test beams through a first fluid in the first fluid cell 116.

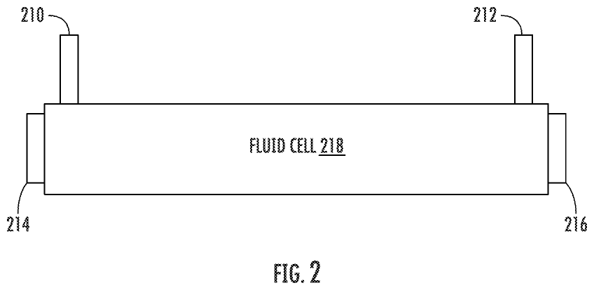

Referring now to FIG. 2 a schematic diagram illustrating a fluid cell 218 is provided in accordance with various embodiments of the present disclosure. The fluid cell 218 may represent any and/or all of the plurality of fluid cells 114, as for example illustrated by FIG. 1, for example, the first fluid cell or the second fluid cell.

In various embodiments, the fluid cell 218 includes a first window of the fluid cell 214 configured to receive the one or more optical test beams, after reflecting from the first mirror, into the fluid cell 218. The fluid cell 218 contains a corresponding fluid or a fluid composition to be tested using the one or more optical test beams. In various embodiments, the one or more optical test beams interact with the corresponding fluid or fluid composition inside the fluid cell 218, which generates an interferogram. The interferogram may contain information about the type of fluid(s) or the fluid composition in the fluid cell 218. The one or more optical test beams may then exit the fluid cell 218 via the second window of the fluid cell 216.

For example, referring to FIG. 1, the first fluid cell 116 of the plurality of fluid cells includes a first window of the first fluid cell configured to receive the one or more optical test beams 130 after reflecting from the first mirror 120, and a second window of the first fluid cell configured to pass the one or more optical test beams 130 after passing through the first fluid cell 116. The first fluid cell 116 may include an inlet of the first fluid cell configured to pass a first fluid to the first fluid cell 116, and an outlet of the first fluid cell configured to pass the first fluid out of the first fluid cell 116. In some embodiments, the first fluid may be combined with one or more other fluid(s).

For example, referring to FIG. 1, a second fluid cell 118 of the plurality of fluid cells includes a first window of the second fluid cell configured to receive the one or more optical test beams 130 after reflecting from the first mirror, and a second window of the second fluid cell configured to pass the one or more optical test beams 130 after passing through the second fluid cell 118. The second fluid cell 118 may include an inlet of the second fluid cell configured to pass a second fluid to the second fluid cell 118, and an outlet of the second fluid cell configured to pass the second fluid out of the second fluid cell 118. In some embodiments, the second fluid may be combined with one or more other fluid(s).

In various embodiments, the fluid cell 218 may contain the corresponding fluid or fluid composition, or may provide a flow path for the fluid(s) to be tested. In various embodiments, the fluid cell 218 includes an inlet of the fluid cell 210 and an outlet of the fluid cell 212. The fluid(s) may enter the fluid cell 218 through the inlet of the fluid cell 210 and exit the fluid cell 218 through the outlet of the fluid cell 212.

It may be desirable to continually and/or intermittently test or monitor fluid(s) that flow through a pipeline or stored in a container. In various embodiments, a tap may be opened in the pipeline or container such that the fluid(s) flow through the fluid cell 218 via the inlet of the fluid cell 210 and the outlet of the fluid cell 212, or are stored in the fluid cell 218 at least for a period of time. For example, various embodiments of the present disclosure may provide continual and/or intermittent testing, detection, and/or analysis of fluid(s) that flow in a pipeline or stored in a container. For example, the testing, detection, and/or analysis may be done in parallel or in real time while the fluid is flowing in the pipeline or is stored in a container.

Referring to FIG. 1, in various embodiments, the optical fluid detection apparatus 100 includes a second mirror 122. The second mirror 122 may be configured to reflect the one or more optical test beams after passing through the first fluid cell 116. For example, the second mirror 122 may receive and reflect the one or more optical test beams 130 after it passes through the fluid(s) in the first fluid cell 116 and generates a corresponding interferogram and exits the second window of the first fluid cell.

In various embodiments, the optical fluid detection apparatus 100 includes a third mirror 124 configured to receive and reflect the one or more optical test beams after reflecting from the second mirror 122. In various embodiments, the optical fluid detection apparatus 100 includes an optical detector 108 configured to receive the one or more optical test beams after reflecting from the third mirror 124.

In various embodiments, the optical detector 108 may include an optical fiber 110 and an optical element 112. The optical element 112 may facilitate receiving the one or more optical test beams 130 after reflecting from the third mirror 124. For example, the optical element 112 may be a collimating or a focusing lens. In some embodiment, the optical element 112 may include a high optical absorption material and/or an antireflection material. In various embodiments, the optical fiber 110 facilitates placing the optical element 112 and/or provides flexibility in receiving the one or more optical test beams 130 by the optical detector 108.

In various embodiments, the first mirror 120, the second mirror 122, and the third mirror 124 are placed in fixed relative positions with respect to each other. In various embodiments, the first mirror 120, the second mirror 122 and the third mirror 124 are mechanically coupled to each other. For example, the first mirror 120, second mirror 122, and third mirror 124 are mechanically coupled to each other by a physical connection 128. In various embodiments, the physical connection 128 may be made from a rigid material and configured to keep the relative configuration of first mirror 120, second mirror 122, and third mirror 124 by holding them in the same fixed relative position with respect to each other.

In various embodiments, the first mirror 120, second mirror 122, and third mirror 124 are configured to rotate around a rotation axis 134 while keeping their relative configuration and/or position with respect to each other using the physical connection 128. In various embodiments, a motor, for example a stepper motor or a servo motor may be used to rotate the first mirror 120, second mirror 122, and third mirror 124 around the rotation axis 134 for example a rotational direction 126.

In various embodiments, the first mirror 120, second mirror 122, and third mirror 124 are configured to rotate such that at each measurement time of a plurality of measurement times, the one or more optical test beams 130 is directed by the first mirror 120 to a first window of a corresponding fluid cell, passes through the corresponding fluid cell, and exits through the second window of the corresponding fluid cell and reflects from the second mirror 122 to the third mirror 124. In various embodiments, the first mirror 120, second mirror 122, and third mirror 124 are rotated with a known angle at each measurement time equal to the angle between two adjacent fluid cells, such that the first mirror 120 and the second mirror 122 are positioned at two ends of a corresponding fluid cell at each measurement time.

In example embodiment, by rotating the mirrors, the optical fluid detection apparatus may use the same optical source and optical detector to test fluid(s) in a plurality of fluid cells. Doing so may, for example, simplify the optical fluid detection apparatus by reducing the number of optical sources and optical detectors for testing fluid(s) in a plurality of fluid cells, hence reduce cost, size, and/or weight of the optical fluid detection apparatus. In some examples, using the optical fluid detection apparatus in accordance with various embodiments of the present disclosure may provide testing and/or monitoring fluid(s) in a plurality of fluid cells at high speed and with low cost.

In an example shown by FIG. 1, at a first measurement time, the first mirror 120 and the second mirror 122 are positioned near two ends of the first fluid cell 116. The first mirror 120 may be configured to reflect the one or more optical test beams 130 to the first window of the first fluid cell and the second mirror 122 is configured to receive the one or more optical test beams after passing through the first fluid cell 116 and through the second window of the first fluid cell. The second mirror 122 may then reflect the one or more optical test beams 130 to the third mirror 124.

In an example, at a second measurement time the first mirror 120 and the second mirror 122 are positioned at the two ends of the second fluid cell 118. The first mirror 120 may be configured to reflect the one or more optical test beams 130 to the first window of the second fluid cell and the second mirror 122 is configured to receive the one or more optical test beams after passing through the second fluid cell 118 and through the second window of the second fluid cell. The second mirror 122 may then reflect the one or more optical test beams 130 to the third mirror 124.

In various embodiments, at each measurement time of a plurality of measurement times, the first mirror 120 is configured to reflect the one or more optical test beams 130 in a direction of a corresponding fluid cell of the plurality of fluid cells 114, and the second mirror 122 is configured to receive the one or more optical test beams 130 after passing through the corresponding fluid cell.

In various embodiments, the optical detector 108 is configured to detect a concentration and/or a presence of the first fluid in the first fluid cell during the first measurement time and a concentration and/or a presence of the second fluid in the second fluid cell during the second measurement time, by detecting an interferogram in the received one or more optical test beams. In various embodiments, a composition of the fluid(s) in the corresponding fluid cell during the corresponding measurement time is determined. For example, the interferogram detected by the optical detector 108 may be used to analyze, determine concentration, composition, and/or presence of one or more fluids inside a fluid cell during the corresponding measurement time. For example, the detected optical beam by optical detector 108 may be used to analyze, determine concentration, composition, and/or presence of one or more fluids inside a fluid cell during the corresponding measurement time.

In various embodiments, the plurality of fluid cells 114 are arranged radially around the first mirror 120. In various embodiments, the first mirror 120, the second mirror 122, and the third mirror 124 are configured to rotate around a rotation axis 134 such that at each measurement time of the plurality of measurement times, the first mirror 120 is configured to reflect the one or more optical test beams 130 in the direction of the corresponding fluid cell of the plurality of fluid cells 114, and the second mirror 122 is configured to receive the one or more optical test beams 130 after passing through the corresponding fluid cell.

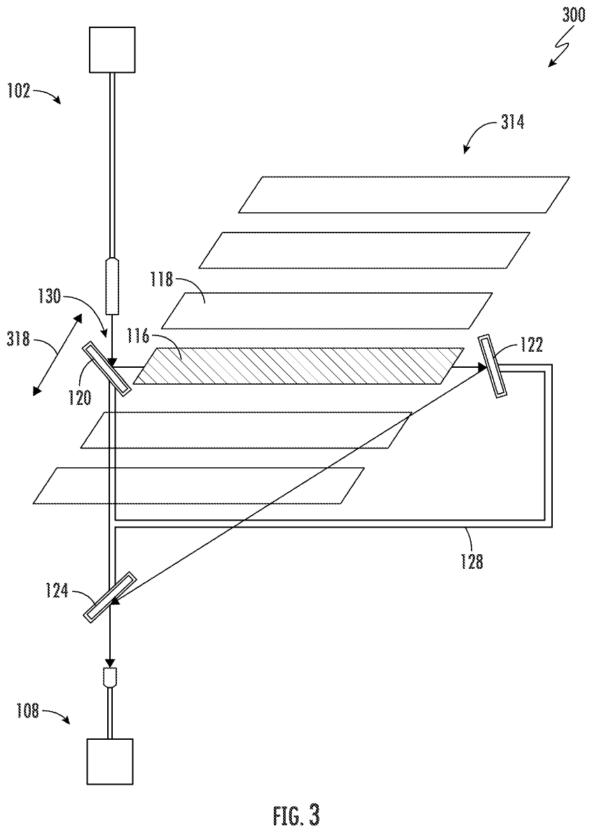

Referring now to FIG. 3 a schematic diagram illustrating an optical fluid detection apparatus 300 is provided in accordance with various embodiments of the present disclosure. In various embodiments, the plurality of fluid cells 314 are arranged linearly, for example in parallel to each other. In various embodiments, the first mirror 120, the second mirror 122, and the third mirror 124 are arranged with respect to each other and/or are mechanically coupled to each other as previously described with respect to FIG. 1. In various embodiments, as provided by optical fluid detection apparatus 300, the optical source 102, the first mirror 120, the second mirror 122, the third mirror 124, and the optical detector 108 are configured to move linearly along a linear direction 318. In various embodiments, the first mirror 120, the second mirror 122, and the third mirror 124 reflect the one or more optical test beams 130 similar to and as previously described with reference to FIG. 1.

In various embodiments, with reference to FIG. 3, the optical source 102 generates one or more optical test beams 130. In various embodiments, at each measurement time of the plurality of measurement times, the first mirror 120 is configured to reflect the one or more optical test beams 130 in the direction of the corresponding fluid cell of the plurality of fluid cells 314, and the second mirror 122 is configured to receive the one or more optical test beams 130 after passing through the corresponding fluid cell. In various embodiments, the third mirror 124 reflects the 130 to optical detector 108. For example, at a first measurement time, the first mirror 120 reflects the one or more optical test beams 130 in the direction of the first fluid cell 116 and the one or more optical test beams 130, after passing through the first fluid cell 116, is reflected from the second mirror 122 and then by the third mirror 124 to the optical detector 108. For example, at a second measurement time, the first mirror 120 reflects the one or more optical test beams 130 in the direction of the second fluid cell 118 and the one or more optical test beams 130, after passing through the second fluid cell 118, is reflected from the second mirror 122 and then by the third mirror 124 to the optical detector 108. In various embodiments, analysis, determination of concentration, composition, and/or presence of one or more fluids inside a fluid cell is performed as previously described.

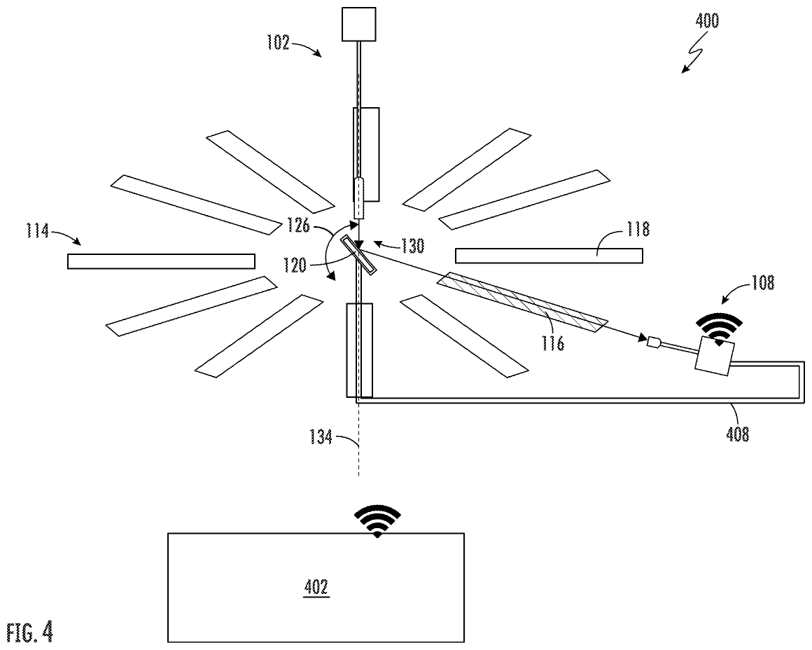

Referring now to FIG. 4 a schematic diagram illustrating an optical fluid detection apparatus 400 is provided in accordance with various embodiments of the present disclosure. In various embodiments, the optical fluid detection apparatus 400 includes an optical source 102 configured to emit one or more optical test beams 130. The optical fluid detection apparatus 400 includes a first mirror 120 configured to reflect the one or more optical test beams 130.

In various embodiments, the optical fluid detection apparatus 400 includes a plurality of fluid cells 114, where each fluid cell of the plurality of fluid cells 114 is configured to pass the one or more optical test beams 130 through a corresponding fluid in the corresponding fluid cell. As previously described, in some embodiments, the corresponding fluid in each fluid cell may include one or more fluids.

In various embodiments, the optical fluid detection apparatus 400 includes an optical detector 108 configured to receive the one or more optical test beams 130 after passing through the fluid cell. In various embodiments, the plurality of fluid cells 114 are arranged radially around the first mirror 120. In various embodiments, the first mirror 120 and the optical detector 108 are configured to rotate around a rotation axis 134.

In various embodiments, the first mirror 120 and the optical detector 108 are placed in fixed relative positions with respect to each other. In various embodiments, in the optical fluid detection apparatus 400, the first mirror 120 and the optical detector 108 are mechanically coupled to each other by physical connection 408.

In various embodiments, the first mirror 120 and the detector are placed in a fixed relative positions with respect to each other and/or are held in fixed relative positions with respect to each other by physical connection 408, and are configured to rotate around the rotation axis 134 such that at a measurement time of a plurality of measurement times corresponding to a fluid cell of the plurality of fluid cells 114, the first mirror 120 is configured to reflect the one or more optical test beams 130 in the direction of the fluid cell, and the optical detector 108 is configured to receive the one or more optical test beams 130 after passing through the fluid cell. In various embodiments, the physical connection 408 may be made from a rigid material and configured to keep the relative configuration of first mirror 120 and optical detector 108 by holding them in the same fixed relative position with respect to each other while they rotate around rotation axis 134. In various embodiments, a motor, for example a stepper motor or a servo motor may be used to rotate the first mirror 120 and optical detector 108 around the rotation axis 134 for example in a rotational direction 126.

In various embodiments, one or more fluid cells of the plurality of fluid cells 114 may be similar to fluid cell 218 as described with reference to FIG. 2.

In an example, the first fluid cell 116 of the plurality of fluid cells includes a first window of the first fluid cell configured to receive the one or more optical test beams 130 after reflecting from the first mirror 120, and a second window of the first fluid cell configured to pass the one or more optical test beams 130 after passing through the first fluid cell 116, an inlet of the first fluid cell configured to pass a first fluid to the first fluid cell 116, and an outlet of the first fluid cell configured to pass the first fluid out of the first fluid cell 116. In some embodiments, the first fluid may be combined with one or more other fluid(s).

For example, a second fluid cell 118 of the plurality of fluid cells includes a first window of the second fluid cell configured to receive the one or more optical test beams 130 after reflecting from the first mirror 120, and a second window of the second fluid cell configured to pass the one or more optical test beams 130 after passing through the second fluid cell 118. The second fluid cell 118 may include an inlet of the second fluid cell configured to pass a second fluid to the second fluid cell 118, and an outlet of the second fluid cell configured to pass the second fluid out of the second fluid cell 118. In some embodiments, the second fluid may be combined with one or more other fluid(s).

In an example, in the optical fluid detection apparatus 400, the optical detector 108 may receive the one or more optical test beams 130 after it passes through the fluid(s) in the first fluid cell 116 and generates a corresponding interferogram and exits the second window of the first fluid cell.

In various embodiments, the first mirror 120 and optical detector 108 are configured to rotate such that at each measurement time of a plurality of measurement times, the one or more optical test beams 130 is directed by the first mirror 120 to a first window of a corresponding fluid cell, passes through the corresponding fluid cell, and exits through the second window of the corresponding fluid cell and received by optical detector 108. In various embodiments, the first mirror 120 and optical detector 108 are rotated with a known angle at each measurement time, such that the first mirror 120 and the optical detector 108 are positioned at two ends of a corresponding fluid cell.

In example embodiment, by rotating the first mirror 120 and optical detector 108, the optical fluid detection apparatus may use the same optical source and optical detector to test fluid(s) in a plurality of fluid cells. Doing so may, for example, simplify the optical fluid detection apparatus by reducing the number of optical sources and optical detectors for testing fluid(s) in a plurality of fluid cells, hence reduce cost, size, and/or weight of the optical fluid detection apparatus. In some examples, using the optical fluid detection apparatus in accordance with various embodiments of the present disclosure may provide testing and/or monitoring fluid(s) in a plurality of fluid cells at high speed and with low cost.

In an example shown by FIG. 4, at a first measurement time, the first mirror 120 and the optical detector 108 are positioned near two ends of the first fluid cell 116. The first mirror 120 may be configured to reflect the one or more optical test beams 130 to the first window of the first fluid cell and the optical detector 108 is configured to receive the one or more optical test beams after passing through the first fluid cell 116 and through the second window of the first fluid cell.

In an example, at a second measurement time the first mirror 120 and the optical detector 108 are positioned near the two ends of the second fluid cell 118. The first mirror 120 may be configured to reflect the one or more optical test beams 130 to the first window of the second fluid cell and the optical detector 108 is configured to receive the one or more optical test beams after passing through the second fluid cell 118 and through the second window of the second fluid cell.

In various embodiments, at each measurement time of a plurality of measurement times, the first mirror 120 is configured to reflect the one or more optical test beams 130 in a direction of a corresponding fluid cell of the plurality of fluid cells 114, and the optical detector 108 is configured to receive the one or more optical test beams 130 after passing through the corresponding fluid cell.

In various embodiments, as previously described, the optical detector 108 is configured to detect a concentration of a fluid in one or more fluid cells of the plurality of fluid cells 114 during the corresponding measurement times by detecting an interferogram in the received one or more optical test beams 130 after passing through the fluid cell. For example, the optical detector 108 is configured to detect a concentration and/or a presence of the first fluid in the first fluid cell during the first measurement time and a concentration and/or a presence of the second fluid in the second fluid cell during the second measurement time, by detecting an interferogram in the received one or more optical test beams. For example, a composition of the fluid(s) in the corresponding fluid cell during the corresponding measurement time is determined. For example, the interferogram detected by the optical detector 108 may be used to analyze, determine concentration, composition, and/or presence of one or more fluids inside a fluid cell during the corresponding measurement time. For example, the detected optical beam by optical detector 108 may be used to analyze, determine concentration, composition, and/or presence of one or more fluids inside a fluid cell during the corresponding measurement time.

In various embodiments, the plurality of fluid cells 114 are arranged radially around the first mirror 120. In various embodiments, the first mirror 120 and optical detector 108 are configured to rotate around a rotation axis 134 such that at each measurement time of the plurality of measurement times, the first mirror 120 is configured to reflect the one or more optical test beams 130 in the direction of the corresponding fluid cell of the plurality of fluid cells 114, and the optical detector 108 is configured to receive the one or more optical test beams 130 after passing through the corresponding fluid cell.

In various embodiments, in the optical fluid detection apparatus 400, the optical detector 108 is configured to transmit detection data to one or more computing devices 402 over a wireless medium or a slip ring. In various embodiments, the optical detector 108 is configured to receive power using a battery or the slip ring.

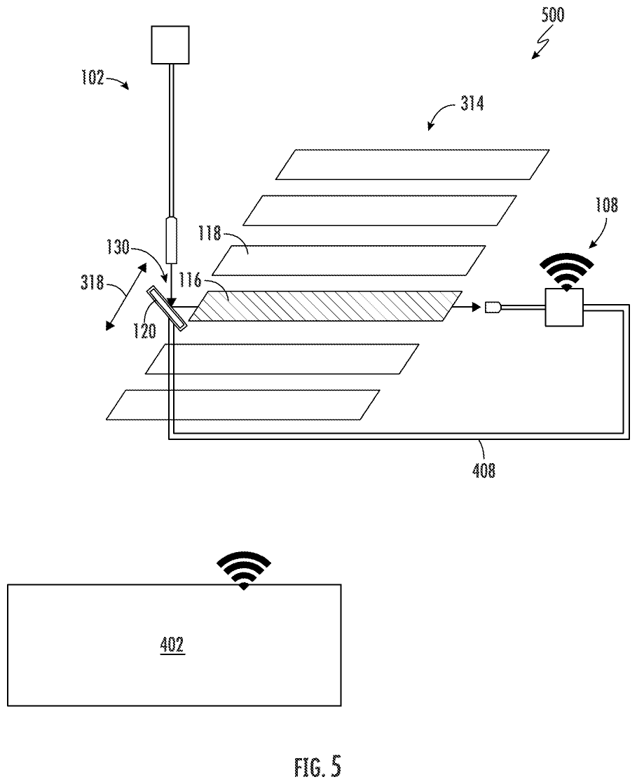

Referring now to FIG. 5 a schematic diagram illustrating an optical fluid detection apparatus 500 is provided in accordance with various embodiments of the present disclosure. In various embodiments, the optical fluid detection apparatus 500 includes an optical source 102 configured to emit one or more optical test beams 130. The optical fluid detection apparatus 500 includes a first mirror 120 configured to reflect the one or more optical test beams 130.

In various embodiments, the optical fluid detection apparatus 500 includes a plurality of fluid cells 114, where each fluid cell of the plurality of fluid cells 114 is configured to pass the one or more optical test beams 130 through a corresponding fluid in the corresponding fluid cell. As previously described, in some embodiments, the corresponding fluid in each fluid cell may include one or more fluids.

In various embodiments, the optical fluid detection apparatus 500 includes an optical detector 108 configured to receive the one or more optical test beams 130 after passing through the fluid cell. In various embodiments, the plurality of fluid cells 114 are arranged linearly with respect to each other. In various embodiments, the first mirror 120 and the optical detector 108 are configured to move linearly for example in direction 318.

In various embodiments, the first mirror 120 and the optical detector 108 are placed in fixed relative positions with respect to each other. In various embodiments, in the optical fluid detection apparatus 400, the first mirror 120 and the optical detector 108 are mechanically coupled to each other by physical connection 408.

In various embodiments, the first mirror 120 and the detector are placed in fixed relative positions with respect to each other and/or are held in fixed relative positions with respect to each other by physical connection 408, and are configured to move linearly, for example along a direction 318, such that at a measurement time of a plurality of measurement times corresponding to a fluid cell of the plurality of fluid cells 114, the first mirror 120 is configured to reflect the one or more optical test beams 130 in the direction of the fluid cell, and the optical detector 108 is configured to receive the one or more optical test beams 130 after passing through the fluid cell. In various embodiments, the physical connection 408 may be made from a rigid material and configured to keep the relative configuration of first mirror 120 and optical detector 108 by holding them in the same fixed relative position with respect to each other while they move linearly along direction 318. In various embodiments, a linear motor, for example a linear stepper motor or a linear servo motor may be used to move the first mirror 120 and optical detector 108 linearly along the direction 318.

In various embodiments, one or more fluid cells of the plurality of fluid cells 114 may be similar to fluid cell 218 as described with reference to FIG. 2.

In various embodiments, the optical source 102 generates one or more optical test beams 130. In various embodiments, at each measurement time of the plurality of measurement times, the first mirror 120 is configured to reflect the one or more optical test beams 130 in the direction of the corresponding fluid cell of the plurality of fluid cells 314, and the optical detector 108 is configured to receive the one or more optical test beams 130 after passing through the corresponding fluid cell. For example, at a first measurement time, the first mirror 120 reflects the one or more optical test beams 130 in the direction of the first fluid cell 116 and the one or more optical test beams 130, after passing through the first fluid cell 116, is detected by the optical detector 108. For example, at a second measurement time, the first mirror 120 reflects the one or more optical test beams 130 in the direction of the second fluid cell 118 and the one or more optical test beams 130, after passing through the second fluid cell 118, is detected by the optical detector 108. In various embodiments, analysis, determination of concentration, composition, and/or presence of one or more fluids inside a fluid cell is performed as previously described.

In various embodiments, the optical detector 108 is configured to detect a concentration of a fluid in the fluid cell during the measurement time by detecting an interferogram in the received one or more optical test beams 130 after passing through the fluid cell.

In various embodiments, the optical detector 108 is configured to transmit detection data to one or more computing devices 402 over a wireless medium or a linear sliding electrical connection. In various embodiments, the optical detector is configured to receive power using a battery or a linear sliding electrical connection.

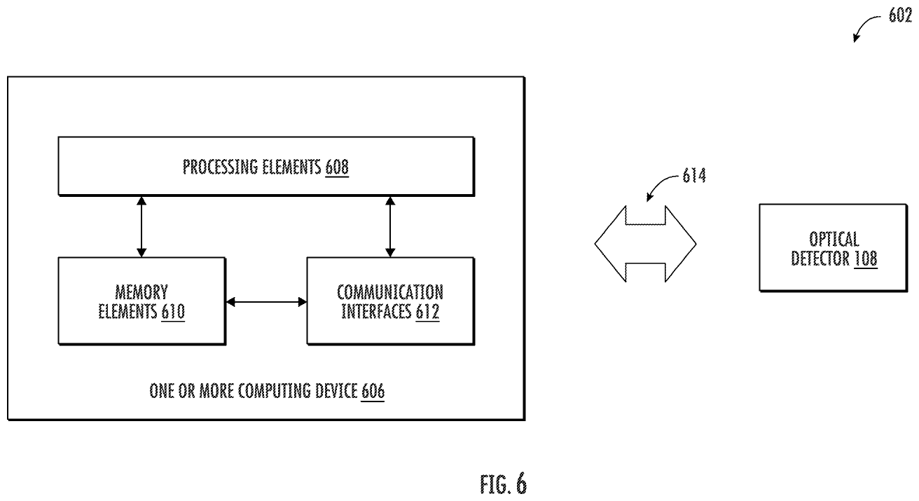

Referring now to FIG. 6 a schematic diagram illustrating one or more computing device 606 in communication with optical detector 108 is provided in accordance with various embodiments of the present disclosure.

In various embodiments, some or all of the one or more computing device 606 may be placed locally or in proximity with optical detector 108 (for example withing a same housing) or remotely from optical detector 108 (for example outside the housing). In various embodiments, the one or more computing device 606 may be placed inside another housing.

In various embodiments, the one or more computing device 606 is in communication with various other components of the optical fluid detection apparatus such as the moving mechanisms, e.g., the rotary or linear motors, rotary or linear step motors, rotary or linear servo motors, and/or optical detector 108 using communication interfaces 612 and over a wired and/or wireless medium 614. A wired medium 614 may be via any physical coupling of conductive materials, such as using wires, slip rings, linear sliding electrical connections, etc.

A wireless medium 614 may include at least one of general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, Zigbee, wireless universal serial bus (USB) protocols, and/or any other wireless

In general, the terms computing apparatus, computer, system, device, entity, and/or similar words used herein interchangeably can refer to, for example, one or more computers, computing entities, desktops, mobile phones, tablets, notebooks, laptops, distributed systems, kiosks, input terminals, servers or server networks, blades, gateways, switches, processing devices, processing entities, controllers, control systems, set-top boxes, relays, routers, network access points, base stations, the like, and/or any combination of devices or entities adapted to perform the functions, operations, and/or processes described herein. Such functions, operations, and/or processes can include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. The one or more computing device 606 can include any computing device including, for example, a mobile device handling and/or processing apparatus configured to perform one or more steps/operations of one or more method or techniques described herein. In some embodiments, the one or more computing device 606 can include and/or be in association with one or more programmable logic controller (PLC), desktop computer(s), laptop(s), server(s), cloud computing platform(s), controller systems, and/or the like. In some example embodiments, the one or more computing device 606 can be configured to receive and/or transmit image processing instructions, data, and/or the like between the one or more optical fluid detection apparatus 100 and/or their components to perform one or more steps/operations of one or more optical fluid detection apparatus 100 handling and/or processing techniques described herein.

The one or more computing device 606 can include, or be in communications with, one or more processing elements 608 (also referred to as processors, processing circuitry, digital circuitry, and/or similar terms used herein interchangeably) that communicate with other elements within the one or more computing device 606 via a bus, for example. As will be understood, the processing elements 608 can be embodied in a number of different ways.

For example, the processing elements 608 can be embodied as one or more complex programmable logic devices (CPLDs), microprocessors, multi-core processors, coprocessing entities, application-specific instruction-set processors (ASIPs), microcontrollers, and/or controllers. Further, the processing elements 608 can be embodied as one or more other processing devices or circuitry. The term circuitry can refer to an entirely hardware embodiment or a combination of hardware and computer program products. Thus, the processing elements 608 can be embodied as integrated circuits, application specific integrated circuits (ASICs), field programmable gate arrays (FPGAs), programmable logic arrays (PLAs), hardware accelerators, digital circuitry, and/or the like.

As will therefore be understood, the processing elements 608 can be configured for a particular use or configured to execute instructions stored in volatile or non-volatile media or otherwise accessible to the processing elements 608. As such, whether configured by hardware or computer program products, or by a combination thereof, the processing elements 608 can be capable of performing steps or operations according to embodiments of the present disclosure when configured accordingly.

In one embodiment, the one or more computing device 606 can further include, or be in communication with, one or more memory elements 610. The one or more memory elements 610 can include non-volatile and/or volatile media. The memory elements 610, for example, can include non-volatile media (also referred to as non-volatile storage, memory, memory storage, memory circuitry and/or similar terms used herein interchangeably). In one embodiment, the non-volatile storage or memory can include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media can store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably can refer to a collection of records or data that is stored in a computer-readable storage medium using one or more database models, such as a hierarchical database model, network model, relational model, entity—relationship model, object model, document model, semantic model, graph model, and/or the like.

In addition, or alternatively, the memory elements 610 can include volatile memory. For example, the one or more computing device 606 can further include, or be in communication with, volatile media (also referred to as volatile storage memory, memory storage, memory circuitry and/or similar terms used herein interchangeably). In one embodiment, the volatile storage or memory can also include one or more volatile storage or memory media, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media can be used to store at least portions of the databases, database instances, database management systems, data, applications, programs, program modules, scripts, source code, object code, byte code, compiled code, interpreted code, machine code, executable instructions, and/or the like being executed by, for example, the processing elements 608. Thus, the databases, database instances, database management systems, data, applications, programs, program modules, scripts, source code, object code, byte code, compiled code, interpreted code, machine code, executable instructions, and/or the like can be used to control certain aspects of the operation of the one or more computing device 606 with the assistance of the processing elements 608 and operating system.

As indicated, in one embodiment, the one or more computing device 606 can also include one or more communication interfaces 612 for communicating with various computing entities, such as by communicating data, content, information, and/or similar terms used herein interchangeably that can be transmitted, received, operated on, processed, displayed, stored, and/or the like. Such communication can be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the one or more computing device 606 can be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, Zigbee, wireless universal serial bus (USB) protocols, and/or any other wireless protocol.

The one or more computing device 606 may perform various steps of various methods for analyzing, determining concentration, composition, and/or presence of one or more fluids, such as gases or liquids, inside a fluid cell, in accordance with various embodiments of the present disclosure.

In various embodiments, referring to the figures and description above, at least one of a first mirror 120, second mirror 122, and/or third mirror 124 may be plane mirrors or off axis parabolic mirrors. In various embodiments, the optical detector may be a photodiode, a camera, and IR sensor, and/or any other optical sensing or imaging device.

Although the methods in accordance with various embodiments provided above depict a particular sequence of operations, the sequence may be altered without departing from the scope of the present disclosure. For example, some of the operations depicted may be performed in parallel or in a different sequence that does not materially affect the function of the methods in accordance with various embodiments. In other examples, different components of an example device or system that implements the methods in accordance with various embodiments may perform functions at substantially the same time or in a specific sequence.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An optical fluid detection apparatus comprising:
an optical source configured to emit one or more optical test beams;
a first mirror configured to reflect the one or more optical test beams;
a plurality of fluid cells including a first fluid cell configured to pass the one or more optical test beams through a first fluid;
a second mirror configured to reflect the one or more optical test beams after passing through the first fluid cell;
a third mirror configured to reflect the one or more optical test beams after reflecting from the second mirror; and
an optical detector configured to receive the one or more optical test beams after reflecting from the third mirror.

2. The optical fluid detection apparatus of claim 1, wherein the first mirror, the second mirror, and the third mirror are placed in fixed relative positions with respect to each other.

3. The optical fluid detection apparatus of claim 1, wherein the first fluid cell comprises:
a first window of the first fluid cell configured to receive the one or more optical test beams after reflecting from the first mirror;
a second window of the first fluid cell configured to pass the one or more optical test beams after passing through the first fluid cell;
an inlet of the first fluid cell configured to pass the first fluid to the first fluid cell; and
an outlet of the first fluid cell configured to pass the first fluid out of the first fluid cell.

4. The optical fluid detection apparatus of claim 3, wherein the first mirror, the second mirror and the third mirror are mechanically coupled to each other and are configured to rotate around a rotation axis such that at a first measurement time, the first mirror and the second mirror are positioned near two ends of the first fluid cell, and the first mirror is configured to reflect the one or more optical test beams to the first window of the first fluid cell and the second mirror is configured to receive the one or more optical test beams after passing through the first fluid cell from the second window of the first fluid cell and reflect it to the third mirror.

5. The optical fluid detection apparatus of claim 4, wherein the plurality of fluid cells includes a second fluid cell wherein the second fluid cell comprises:
a first window of the second fluid cell configured to receive the one or more optical test beams after reflecting from the first mirror;
a second window of the second fluid cell configured to pass the one or more optical test beams after passing through the second fluid cell;
an inlet of the second fluid cell configured to pass a second fluid to the second fluid cell; and
an outlet of the second fluid cell configured to pass the second fluid out of the second fluid cell.

6. The optical fluid detection apparatus of claim 5, wherein at a second measurement time the first mirror and the second mirror are positioned near the two ends of the second fluid cell, and the first mirror is configured to reflect the one or more optical test beams to the first window of the second fluid cell and the second mirror is configured to receive the one or more optical test beams after passing through the second fluid cell from the second window of the second fluid cell and reflect it to the third mirror.

7. The optical fluid detection apparatus of claim 6, wherein the optical detector is configured to detect a concentration of the first fluid in the first fluid cell during the first measurement time and a concentration of the second fluid in the second fluid cell during the second measurement time, by detecting an interferogram in the received one or more optical test beams.

8. The optical fluid detection apparatus of claim 1, wherein at each measurement time of a plurality of measurement times, the first mirror is configured to reflect the one or more optical test beams in a direction of a corresponding fluid cell of the plurality of fluid cells, and the second mirror is configured to receive the one or more optical test beams after passing through the corresponding fluid cell.

9. The optical fluid detection apparatus of claim 8, wherein the plurality of fluid cells is arranged radially around the first mirror, and wherein the first mirror, the second mirror, and the third mirror are configured to rotate around a rotation axis such that at each measurement time of the plurality of measurement times, the first mirror is configured to reflect the one or more optical test beams in the direction of the corresponding fluid cell of the plurality of fluid cells, and the second mirror is configured to receive the one or more optical test beams after passing through the corresponding fluid cell.

10. The optical fluid detection apparatus of claim 8, wherein the plurality of fluid cells is arranged linearly, and wherein the first mirror, the second mirror, and the third mirror are configured to move linearly such that at each measurement time of the plurality of measurement times, the first mirror is configured to reflect the one or more optical test beams in the direction of the corresponding fluid cell of the plurality of fluid cells, and the second mirror is configured to receive the one or more optical test beams after passing through the corresponding fluid cell.

11. An optical fluid detection apparatus comprising:
an optical source configured to emit one or more optical test beams;
a first mirror configured to reflect the one or more optical test beams;
a plurality of fluid cells, wherein each fluid cell of the plurality of fluid cells is configured to pass the one or more optical test beams through a corresponding fluid; and
an optical detector configured to receive the one or more optical test beams after passing through the fluid cell,
wherein the plurality of fluid cells is arranged radially around the first mirror, and wherein the first mirror and the optical detector are configured to rotate around a rotation axis.

12. The optical fluid detection apparatus of claim 11, wherein the first mirror and the optical detector are mechanically coupled to each other.

13. The optical fluid detection apparatus of claim 11, wherein the first mirror and the optical detector are placed in fixed relative positions with respect to each other and are configured to rotate around the rotation axis such that at a measurement time of a plurality of measurement times corresponding to the fluid cell, the first mirror is configured to reflect the one or more optical test beams in the direction of the fluid cell, and the optical detector is configured to receive the one or more optical test beams after passing through the fluid cell.

14. The optical fluid detection apparatus of claim 13, wherein the optical detector is configured to detect a concentration of a fluid in the fluid cell during the measurement time by detecting an interferogram in the received one or more optical test beams after passing through the fluid cell.

15. The optical fluid detection apparatus of claim 14, wherein the optical detector is configured to transmit detection data to one or more computing devices over a wireless medium or a slip ring, and the optical detector is configured to receive power using a battery or the slip ring.

16. An optical fluid detection apparatus comprising:
an optical source configured to emit one or more optical test beams;
a first mirror configured to reflect the one or more optical test beams;
a plurality of fluid cells, wherein each fluid cell of the plurality of fluid cells is configured to pass the one or more optical test beams through a corresponding fluid; and
an optical detector configured to receive the one or more optical test beams after passing through the fluid cell,
wherein the plurality of fluid cells is arranged linearly with respect to each other, and wherein the first mirror and the optical detector are configured to move linearly.

17. The optical fluid detection apparatus of claim 16, wherein the first mirror and the optical detector are mechanically coupled to each other.

18. The optical fluid detection apparatus of claim 16, wherein the first mirror and the optical detector are placed in fixed relative positions with respect to each other and are configured to move linearly such that at a measurement time of a plurality of measurement times corresponding to the fluid cell, the first mirror is configured to reflect the one or more optical test beams in the direction of the fluid cell, and the optical detector is configured to receive the one or more optical test beams after passing through the fluid cell.

19. The optical fluid detection apparatus of claim 18, wherein the optical detector is configured to detect a concentration of a fluid in the fluid cell during the measurement time by detecting an interferogram in the received one or more optical test beams after passing through the fluid cell.

20. The optical fluid detection apparatus of claim 19, wherein the optical detector is configured to transmit detection data to one or more computing devices over a wireless medium or a linear sliding electrical connection, and the optical detector is configured to receive power using a battery or the linear sliding electrical connection.
